(19) United States
(12) Patent Application Publication
(10) Pub. No.: US 2008/0272253 A1
(43) Pub. Date: Nov. 6, 2008

(54) DERAILLEURBRACKET FOR A BICYCLE

(76) Inventor: Peng-Yu TSENG, Taipei (TW)

Correspondence Address: PATENTTM.US, P. O. BOX 82788, PORTLAND, OR, 97282-0788, US

(21) Appl. No.: 11/744,136

(22) Filed: May 3, 2007

(51) Int. Cl. F16C 1/10

(52) U.S. Cl. 248/200

(57) ABSTRACT

A derailleur bracket for a derailleur of a bicycle is made of carbon fiber by a computer numerical control lathe and has an upper end, a lower end, a front side, two sidewalls, an upper through hole, a lower through hole and a mounting recess. The upper through hole is formed through the sidewalls of the derailleur bracket in the upper end. The lower hole is formed through the sidewalls of the derailleur bracket in the lower end. The mounting recess is formed in the front side of the derailleur bracket.

### BACKGROUND OF THE INVENTION

1. Field of the Invention

The present invention relates to a derailleur bracket, and more particularly to a derailleur bracket for a bicycle and that is lighter and allows the rear derailleur to operate efficiently and precisely.

2. Description of Related Art

A conventional derailleur bracket is connected to a bicycle having a frame with a rear fork a chain, a rear wheel mounted in the rear fork and a rear derailleur connected to the chain. The conventional derailleur bracket is connected to the bicycle between the rear derailleur and the rear fork, and is made of aluminum alloy. When the chain is shifted by the rear derailleur, the conventional derailleur bracket is subjected to a shear force by the rear derailleur and produces a deformation. The deformation of the conventional derailleur bracket can influence the efficiency and accurate of the rear derailleur.

To increase the structure strength of the conventional derailleur bracket to resist the shear force of the rear derailleur requires a large amount of material therefore, increasing weight and cost of manufacturing the conventional derailleur bracket. Therefore, a derailleur bracket for a rear derailleur for a bicycle that is both light and strong and allows the rear derailleur to operate efficiently and precisely is required.

To overcome the shortcomings, the present invention tends to provide a derailleur bracket for a rear derailleur of a bicycle to mitigate or obviate the aforementioned problems.

### SUMMARY OF THE INVENTION

The main objective of the present invention is to provide a derailleur bracket for a rear derailleur of a bicycle that allows the rear derailleur to operate efficiently and precisely.

The derailleur bracket is made of carbon fiber by a computer numerical control lathe and has an upper end, a lower end, a front side, two sidewalls, an upper through hole, a lower through hole and a mounting recess. The upper through hole is formed through the sidewalls of the derailleur bracket in the upper end. The lower hole is formed through the sidewalls of the derailleur bracket in the lower end. The mounting recess is formed in the front side of the derailleur bracket.

The derailleur bracket is lighter and resists the shear force caused by the rear derailleur, therefore allowing the rear derailleur to operate efficiently and precisely.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a derailleur bracket in accordance with the present invention; and

FIG. 2 is a side view of the derailleur bracket for a rear derailleur of a bicycle in FIG. 1.

### DETAILED DESCRIPTION OF THE PREFERRED EMBODIMENT

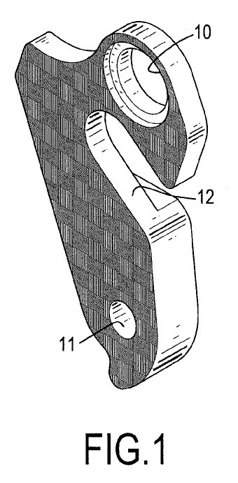

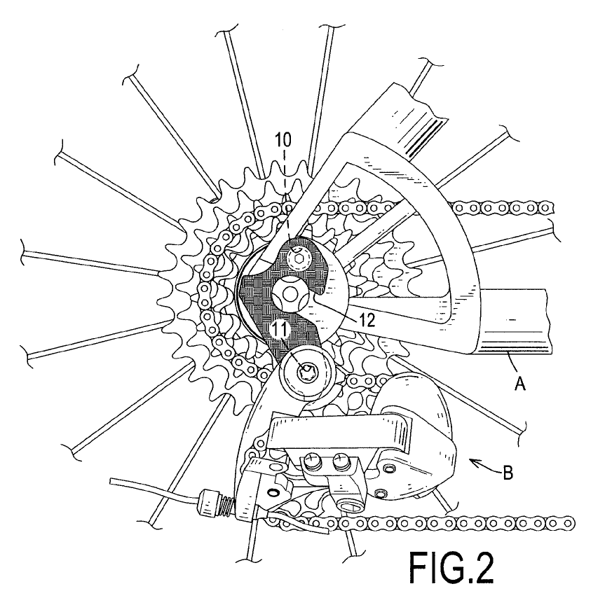

With reference to FIGS. 1 and 2, a derailleur bracket in accordance with the present invention for a bicycle having a rear wheel mounted in a rear fork (A) with a spindle, a chain and a rear derailleur (B) connected to the chain.

The rear wheel is mounted in a wheel recess by the spindle and has a sprocket set.

The rear derailleur (B) is mounted on the derailleur bracket, and the derailleur bracket is made of carbon fiber, is mounted around the wheel recess of the rear fork and comprises an upper end, a lower end, a front side, two sidewalls, an upper through hole (10), a lower through hole (11) and a mounting recess (12).

The upper through hole (10) is formed through the sidewalls of the derailleur bracket in the upper end by a wolfram steel drill bit of a computer numerical control lathe, and is mounted securely on the rear fork (A) of the bicycle.

The lower hole (11) is formed through the sidewalls of the derailleur bracket in the lower end by the wolfram steel drill bit of the computer numerical control lathe, and is connected securely to the rear derailleur (B) of the bicycle.

The mounting recess (12) is formed in the front side of the derailleur bracket and is mounted around wheel recess of the rear fork (A).

In addition, the computer numerical control lathe has an oil cooling leach to filter the scrap of the carbon fiber when the derailleur bracket is made by the computer numerical control lathe.

The derailleur bracket for a rear derailleur of a bicycle as described has the following advantages.

1. The structure strength and the weight of the derailleur bracket made of carbon fiber is stronger and lighter than the conventional derailleur bracket made of aluminum alloy.

2. The derailleur bracket can provide a good hardness to resist the shear forces caused by the rear derailleur (B) of the bicycle, and allows the rear derailleur (B) to operate efficiently and precisely.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A derailleur bracket for a derailleur of a bicycle comprising
an upper end;
a lower end;
a front side;
two sidewalls;
an upper through hole being formed through the sidewalls of the derailleur bracket;
a lower through hole being formed through the sidewalls of the derailleur bracket in the lower end; and
a mounting recess being formed in the front side of the derailleur bracket,
wherein the derailleur bracket is made of carbon fiber by a computer numerical control lathe.
